(19) United States
(12) Patent Application Publication
(10) Pub. No.: US 2006/0032516 A1
(43) Pub. Date: Feb. 16, 2006

(54) Method for the recovery of ash rate following metal etching

(75) Inventors: Srivatsa Kundalgurki, Dresden (DE); Haruhiro Harry Goto, Saratoga, CA (US); David Lee Chen, San Jose, CA (US)

Correspondence Address: MORRISON & FOERSTER LLP, 1650 TYSONS BOULEVARD, SUITE 300, MCLEAN, VA, 22102, US

(73) Assignees: Infineon Technologies AG, Munich (DE); Novellus Systems, Inc., San Jose, CA (US)

(21) Appl. No.: 10/902,268

(22) Filed: Jul. 30, 2004

(51) Int. Cl. B08B 6/00

(52) U.S. Cl. 134/1.1

(57) ABSTRACT

A process for removing residue from one or more surfaces of chamber components exposed to the interior of a semiconductor process chamber. A plasma chamber is supplied with a gas mixture including nitrogen (N₂) and hydrogen (H₂), the nitrogen and hydrogen being included in volume % from 2 to 10 of hydrogen and from 98 to 90 of nitrogen, thereby forming a plasma in the plasma chamber so as to decompose a portion of the nitrogen (N₂) and hydrogen (H₂) to atomic N and/or H. The interior of the semiconductor process chamber is thus exposed to at least a portion of the atomic N and/or H.

### TECHNICAL FIELD OF THE INVENTION

The invention relates to processes for cleaning or removing residues from the interior surfaces of a vacuum chamber used for fabricating electronic devices. More specifically, the invention relates to a method for the recovery of ash rate in such vacuum chambers following metal etching, in particular tungsten etching.

### BACKGROUND OF THE INVENTION

Processes for fabricating electronic devices containing semiconductors generally include steps in which layers or features of material are deposited or patterned (i.e., etched) within a vacuum chamber, generally called a semiconductor process chamber. The chemical by-products and unused reagents of such deposition or etch processes are mostly exhausted from the chamber by an exhaust pump, but some residue unavoidably deposits on the chamber wall and on other surfaces within the chamber. Such residue must be cleaned or removed periodically in order to maintain consistent process conditions and to prevent the residue from flaking off and contaminating the electronic device being fabricated.

A conventional method of cleaning residue from the interior surfaces of the chamber is to supply to the chamber interior a gas mixture containing radicals produced by plasma decomposition. EP-A-1 138 802 discloses a fluorine process for cleaning a semiconductor process chamber. Molecular fluorine gas (F₂) is used as the principal precursor reagent.

In DRAM manufacture, the use of fluorine containing chemistries for cleaning polymers in contact Vias using suitably equipped resist strip chambers is common practice.

One such application is the polymer clean process in the so called Contact 1 Vias with exposed Metal 0 (bitline) Tungsten at the bottom of the subject contacts. It has been recently discovered that performing such a clean on the Novellus Gamma apparatus (manufactured by Novellus Systems, Inc.) using a fluorine based chemistry leads to the cumulative poisoning of the process chamber resulting in a significant drop in ash rate as well as the loss of ash rate uniformity. An investigation of this phenomenon on other competing resist strip systems such as the Mattson Aspen and the Ulvac Enviro revealed that the observed ash rate depression is also observed on those chambers as well.

Ash rate of the Novellus Gamma chamber following this poisoning cannot be recovered by known plasma clean methods in a manufacturable time frame. Also, the multi (radio frequency) RF station design of the Novellus Gamma chamber and the gas box design where the availability of the gas chemistries for overcoming the problem being restricted to the last two RF stations in the process chamber complicates and extends the ash rate recovery process.

The Novellus Gamma tool design of Novellus Systems, Inc. supports the sequential processing of up to six wafers in a common process chamber and is generally used for the purposes of resist, clean and “light” metal etch applications. The process chamber is in general plumbed with four process gases: O₂, N₂, N₂/H₂ and CF₄. These are the standard gases used by most vendors that manufacture chambers for the purposes of resist strip and residue clean.

In order to support the requirements of the normal ash process, clean gases, N₂/H₂ and CF₄ are plumbed in such a way that preferential flow of these gases are directed towards the last two stations in the process chamber. This approach of resist strip capability on the preliminary stations followed by the option to subsequently perform reduction of defects using the clean gases works well for traditional strip application. In contrast, the competitors use a process chamber with the capability of processing one or two wafers at a time. The sequence of resist strip and wafer defect cleaning is achieved by sequentially changing the process chemistry being supplied to the chamber.

### SUMMARY OF THE INVENTION

The present invention discloses a manufacturable in situ chamber conditioning method that eliminates the impact of metal etch on chamber ash rate and uniformity. The present invention therefore provides a solution to ash rate excursion following metal etch.

The present invention relates to a manufacturable ash rate recovery method following metal etch. The present invention addresses the above problems by providing a process for removing residue from one or more surfaces of chamber components exposed to the interior of a semiconductor process chamber, comprising:
supplying to a plasma chamber a gas mixture including nitrogen (N₂) and hydrogen (H₂) from 2 to 10 Vol % of hydrogen and from 98 to 90% of nitrogen; forming a plasma in the plasma chamber so as to decompose a portion of the nitrogen (N₂) and hydrogen (H₂) to atomic N and/or H; and exposing the interior of the semiconductor process chamber to at least a portion of said atomic N and/or H.

The process gas mixture comprises in volume % preferably from 2 to 10%, more preferably from 3 to 6 and most preferred from 3 to 5% of hydrogen and from 98 to 90%, more preferably from 97 to 94% and most preferred from 97 to 95% of nitrogen.

### BRIEF DESCRIPTION OF THE DRAWINGS

FIG. 1 shows a schematic drawing of a process chamber for use in a process according to the invention.

FIGS. 2 and 3 show graphs of ash rate vs. Wafer count for embodiments of the invention.

### DETAILED DESCRIPTION OF THE INVENTION

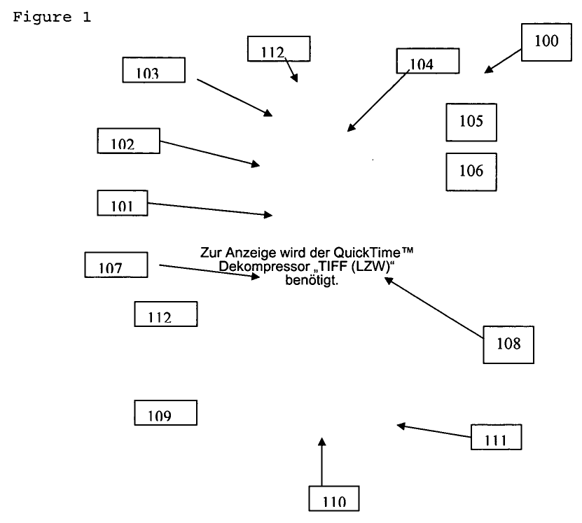

FIG. 1 shows a Novellus Gamma Process chamber 100, which supports the sequential processing of up to 6 wafers 1 to 6 at RF stations 101, 102, 103, 104, 105 and 106. The station 101 is the so-called “pre-heating station”. Further, cassettes with a batch of wafers could be loaded on stations 109, 110 and 111 in preparation for plasma processing. 107 and 108 are in- or outlets, specifically in the form of a vacuum chamber which can be vented and/or flushed with gas. L in inlet 107 denotes “load lock” and U in outlet 108 denotes “unload lock”. 112 is an atmospheric robot for the transfer of the wafers from the cassettes 109, 110 and 111 to the load lock. Inside the chamber 100, a further robot not shown in FIG. 1 transfers the wafers from the load lock to the pre-heat station while an indexer robot sequentially transfers the wafers from the pre-heat station to the subsequent RF stations. The wafers after processing are transferred to the unload lock from where the atmospheric robot does a final wafer transfer back to the cassette on stations 109, 110 or 111 where it originated. The process chamber 100 is plumbed with four process gases, oxygen, nitrogen, a mixture of nitrogen and hydrogen (forming gas) and CF₄. During normal processing, the CF₄/forming gas flow preferentially takes places to the RF stations 105 and 106, i.e. the last two stations. In the present invention, during the ash rate recovery process, the gas flows are adjusted such that the CF₄/forming gas flow is able to sufficiently reach all parts of the process chamber facilitating effective ash rate recovery and chamber decontamination.

In a preferred method according to the present invention, the recovery method is automated to minimize tool down time, to avoid the risk of cross contamination as well as maintain process stability.

The ash rate recovery method of the present invention is not limited to the Novellus Gamma platform, but can be also applied to other ash tool platforms.

In a preferred embodiment of the present invention, the gas mixture contains in addition to nitrogen (N₂) and hydrogen (H₂) in volume % preferably from 2 to 10%, more preferably from 3 to 6 and most preferred from 3 to 5% of hydrogen and from 98 to 90%, more preferably from 97 to 94% and most preferred from 97 to 95% of nitrogen as a further component CF₄.

In an even more preferred embodiment, the gas mixture contains furthermore O₂. It has been found that the addition of O₂ can avoid the formation of polyfluoroethylene type polymers generated in the plasma when hydrogen gas is used in combination with CF₄.

The method of the present invention has a number of advantages. For example, it does not cause ash rate or uniformity degradation when used following standard ash process without metal etch.

Moreover, with the removal of metal etch residues from the process chamber, the risk of cross-contamination between wafers and lots is minimized.

### EXAMPLES

The present invention is further illustrated by way of examples which are not meant to be limiting the scope of the invention.

### Example 1

Ash rate depression following W, AlCu and TiN etch could be recovered using a gas mixture of 2000 sccm O₂, 8000 sccm N₂/H₂ and 40 sccm CF₄ at a process pressure of 1100 mtorr and an RF power of 2000 W. The processing time for such a recovery following metal etch was 60 seconds.

| | | Ash rate |
|---|---|---|
| | Ash rate | non-uniformity % |
| Condition | (/min) | (1 sigma) |
| Baseline before metal | 3.4 | 4.9 |
| After [symbol] etch | 3.1 | 8.7 |
| After applying proposed | 3.4 | 4.5 |
| chamber recovery method | | |
| Baseline before metal | 3.2 | 4.2 |
| After [symbol] etch | 3.1 | 8.0 |
| After applying proposed | 3.3 | 4.3 |
| chamber recovery method | | |
| Baseline before metal | 3.3 | 4.3 |
| After [symbol] etch | 3.0 | 8.8 |
| After applying proposed | 3.2 | 4.1 |
| chamber recovery method | | |

### Example II

The risk of Tungsten contaminant transfer from a contaminated process chamber to wafers being processed was eliminated by conditioning the process chamber immediately following Tungsten etch. The conditioning method was to expose the process chamber for 60 seconds to a gas mixture containing 2000 sccm O₂, 8000 sccm N₂/H₂ and 40 sccm CF₄ at a process pressure of 1100 mtorr and an RF power of 2000 W.
a. Two wafers with exposed Tungsten film were etched in the process chamber. The total Tungsten etched from the two wafers was 189 nm.
b. Following the Tungsten etch, a wafer for monitoring Tungsten cross-contamination was processed through the process chamber. An ICP-MS technique was used to measure the amount of Tungsten picked up by this monitor wafer. A Tungsten contamination level of 84.9E10 atoms/cm² was documented.

The chamber was then conditioned using the proposed technique and a new monitor wafer was processed through the tool to recheck the level of Tungsten contamination. An ICP-MS evaluation indicated a Tungsten contamination level of 0.126E10 atoms/cm². An acceptable metal contamination level specified for semiconductor equipment is typically 10E10 atoms/cm².
c. A 99.85% reduction in wafer W contamination level was achieved following chamber recovery process.
d. W etch residues are not fully exhausted from the process chamber during normal metal etch processing. Post-processing following metal etch is necessary to de-contaminate the process chamber. Without the decontamination process, the potential for cross contamination of wafers with residual metal species in the process chamber exists.

The present invention allows to remove the blue WO₂ coating along the chamber walls and top chamber cover plate which is visible in a poisoned chamber. The WO₂ is presumably formed by the reaction of WF5 or WFₓ with oxygen radical which firstly gives rise to a white residue visible in a poisoned chamber which is believed to be WOF₄. This reaction is believed to be the main scavenging reaction to suppress ash rate. WOF₄ may undergo further transformation to WO₂F₂ and WO₃ either through hydrolysis or through further scavenging of oxygen radicals from the plasma.

### Example III

A design of experiment was performed to evaluate the process window for chamber ash rate and uniformity recovery by intentionally contaminating the process chamber with Tungsten. During the chamber ash rate recovery, O₂, Forming gas, CF₄ flows were varied and so was the applied RF plasma power. Results from this experiment are tabulated below. A percentage recovery higher than ˜95% indicates complete recovery of the indicated parameter since small variations in parameters from one run to the next is to be expected.

| | | Forming | | | | |
|---|---|---|---|---|---|---|
| | O2 | gas | CF4 | RF | Ash Rate | Uniformity |
| Exper- | Flow | Flow | Flow | Bias | Recovery | Recovery |
| iment | (sccm) | (sccm) | (sccm) | (W) | (%) | (%) |
| 1 | 0 | 4000 | 20 | 1000 | 82.2 | 90.5 |
| 2 | 0 | 4000 | 40 | 2000 | 79.2 | 96.0 |
| 3 | 0 | 8000 | 40 | 1000 | 121.0 | 86.7 |
| 4 | 2000 | 4000 | 20 | 2000 | 90.9 | 84.1 |
| 5 | 0 | 8000 | 20 | 2000 | 104.2 | 76.8 |
| 6 | 2000 | 8000 | 40 | 2000 | 69.2 | 115.2 |
| 7 | 2000 | 8000 | 20 | 1000 | 80.6 | 49.7 |
| 8 | 2000 | 4000 | 40 | 1000 | 96.1 | 67.4 |

The chamber pressure was in range of from 0.5 to 2 Torr, preferred of from 0.5 to 2 Torr, most preferred of from 0.8 to 1.5 Torr. In a specific embodiment of the invention, the pressure was 1.1 Torr.

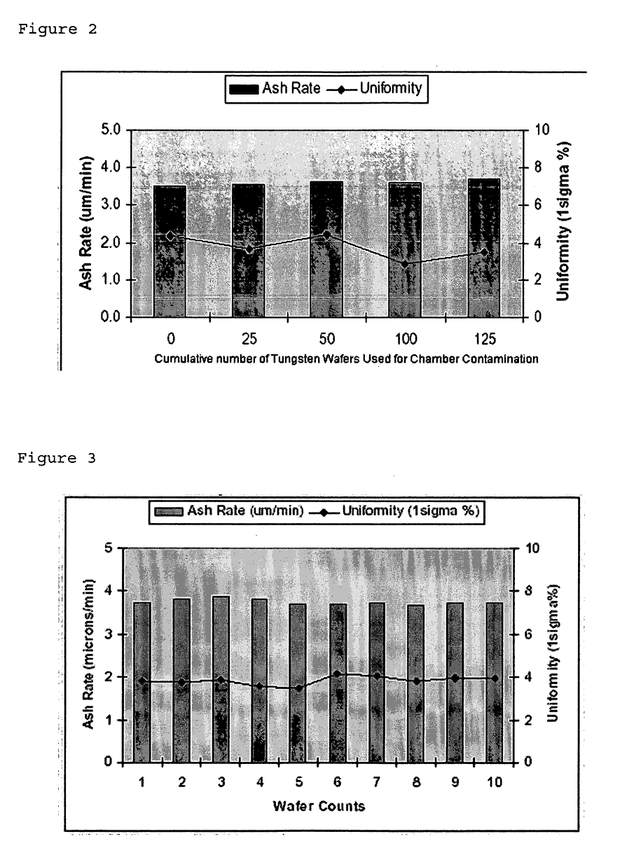

The process used in experiment 2 above was further evaluated by processing 25 Tungsten wafers at a time to contaminate the process chamber and then running the 60 second recovery process. The process of running the 25 Tungsten wafers and the recovery was repeated 4 times to test the process stability. The stability of the ash rate and uniformity is evident from the graph of FIG. 2.

### Example IV

In order to demonstrate that the ash rate recovery process does not degrade the chamber ash rate and uniformity performance when applied on chambers not exposed to Tungsten contamination, the recovery process was run following the processing of bare Si wafers. Following the completion of the 60 second recovery process, the chamber ash rate and uniformity was qualified. Results from a series of back-to-back experiments to demonstrate stability is shown in the graph of FIG. 3.

What is claimed is:

1. A process for removing residue from at lest one surface of chamber components exposed to an interior of a semiconductor process chamber, comprising:
supplying to a plasma chamber a gas mixture including nitrogen and hydrogen, wherein the nitrogen and hydrogen are included in volume % from 2 to 10 of hydrogen and from 98 to 90 of nitrogen, thereby forming a plasma in the plasma chamber so as to decompose a portion of the nitrogen and hydrogen to atomic N and/or H; and
exposing the interior of the semiconductor process chamber to at least a portion of the atomic N and/or H.

2. The process according to claim 1, wherein the exposing comprises transporting a portion of the atomic N and/or H from the plasma chamber into the semiconductor process chamber.

3. The process according to claim 1, wherein the plasma chamber and the semiconductor process chamber are the same chamber.

4. The process according to claim 1, further comprising:
before the exposing, etching a film on a substrate within the semiconductor process chamber so as to produce metal residues on the surfaces of chamber components.

5. The process according to claim 4, wherein the metal residues are metals selected from the group consisting of W, Al, Ti and alloys thereof.

6. The process according to claim 1, wherein the gas mixture includes also CF₄.

7. The process according to claim 3, wherein the gas mixture includes also O₂.

8. The process according to claim 1, wherein the gas mixture comprises nitrogen and hydrogen in volume % from 3 to 6% of hydrogen and from 97 to 94% of nitrogen.

9. The process according to claim 6, wherein the gas mixture comprises CF₄ and hydrogen, wherein the CF₄ content is less than or equal to 40 sccm.

10. The process according to claim 5, wherein the metal etch residues are removed from the process chamber.
